(19) United States
(12) Patent Application Publication
(10) Pub. No.: US 2019/0100271 A1
(43) Pub. Date: Apr. 4, 2019

(54) TRANSPORTATION DEVICE WITH NON-TRANSPORTATION FEATURE

(71) Applicant: Invent North America, LLC, Rehoboth, MA (US)

(72) Inventor: Brian Joseph Quaglia, Rehoboth, MA (US)

(21) Appl. No.: 15/937,907

(22) Filed: Mar. 28, 2018

Related U.S. Application Data
(63) Continuation-in-part of application No. 15/821,781, filed on Nov. 23, 2017, now abandoned.
(60) Provisional application No. 62/439,038, filed on Dec. 25, 2016.

(51) Int. Cl. B62K 9/02; B62K 21/12

(52) U.S. Cl. CPC B62K 9/02; B62K 2700/56; B62K 21/12

(57) ABSTRACT

The present invention relates to a children's transport device, scooter, bicycle, wagon, and/or ride-on with added non-transportation features that are activated and powered electronically, mechanically, and/or by movement of wheels or other part of the device, whereby rider or user in various embodiments can be situated in at least one of the following positions: standing, sitting, knelling, or squatting, and the invention could include at least one seat. In at least one embodiment the non-transportation feature is powered through electric or mechanical connection to the wheels or intermediary of vehicle so that rotation of wheels during movement will activate and power the non-transport features. In at least one embodiment the vehicle could also be adapted for pedaling action to activate and/or control the non-transportation features. An ejecting mechanism may be included in some embodiments for toy or other object ejecting into closed embodiments or into the ambient during movement.

### PRIORITY

This application is a continuation in part of and takes the priority of and the benefit of application Ser. No. 15/821,781 filed on Nov. 23, 2017 which took priority of and the benefit of provisional application No. 62/439,038 filed on Dec. 25, 2016. Both prior applications are incorporated herein in their entireties by this reference.

### FIELD OF THE INVENTION

The present invention relates to an improved child mobility and transport device and more particularly to an improved child's active transportation device with at least one added non-transportation feature(s).

### SUMMARY AND OVERVIEW

This invention is a child's mechanical and/or electric mobility and transportation device comprising of at least one transportation device, and at least one non-transportation device which is comprised of at least one non-transportation feature or non-transportation feature device. The said at least one transportation device further is comprised of at least one of the following; at least one of steering, balancing, stabilizing, or gripping device, rod, handle, knob; said at least one of a steering, balancing. stabilizing, or gripping device, rod, handle, knob may be permanently or removably affixed to a wheel base or intermediary(s) or may be permanently or removably attached to or be one or more parts of transportation device, or said intermediary(s), or wheel base, or platform, or mechanism or device for affixing: or at least one wheel; at least one attaching and/or connecting device for attaching and/or connecting the said steering, balancing, stabilizing, or gripping device, neck, rod, handle, knob steering rod to the wheel base or intermediary(s); said wheel base having said platform and mechanism or device for affixing, to as many as at least one wheel, or to a plurality of wheels to said wheel base, and having said plurality of wheels and associated equipment: whereby said attaching and/or connecting device attaches to said at least one wheel; whereby said attaching and/or connecting device that attaches to at least one wheel may be permanently or removably attached to or be one or more parts of transportation device, or said intermediary(s), or said wheel base, or said platform,

or said mechanism or device for affixing, or said steering, balancing, stabilizing, or gripping device, rod, handle, knob; and said at Least non-transportation feature(s) is/are powered electrically or through mechanical connection. The invention's non-transportation features may be powered electrically or through a mechanical connection to the wheels or intermediary(s) of the vehicle and additionally comprising a power generating device so that rotation of the wheels during movement will activate and power the non-transportation features. The vehicle could also be adapted for pedaling to activate, control, and/or power the sad non-transportation features(s). An ejecting mechanism may be included in some embodiments for toy or other object ejecting into closed environments or into open environments or the ambient during movement. The invention may have that wherein said at least one of a steering, balancing, stabilizing or gripping device, or rod, handle, knob turning device, if present, further comprises a turning device. Various embodiments can be situated to accommodate the user in at least one of the following positions: standing, sitting, or squatting.

The invention may be additionally comprising at least one seat, or seat back. The invention may additionally comprise at least one of brakes and/or a braking system and may include a braking release. The invention additionally may comprise of at least one of the following: a wheel turning mechanism, front wheel turning rod, front wheel mount, pivot bolts, rear wheel axles and/or front wheel axles. The invention may additionally be comprised of a safety strap or other device to tether the device to at least one non-riding person. The invention may be in part or in whole made of at least one of the following: plastic, rubber wood, metal, nylon, fabric, ceramic, fiberglass, and/or polyurethane. The associated equipment comprises at least one of the following: screws, nuts, bolts, axle, rim, hub caps, or caps, covers, ball bearings, spokes, front wheel(s), rear wheel(s), front wheel turning rod, rear wheel turning rod, front wheel mounts and pivot bolts, rear wheel mounts and pivot bolts, rear wheel axles, front wheel axles, rubber, plastic, metal, fiberglass, or polyurethane.

The at least one non-transportation feature is at least one of the following:

At least one design, such as butterfly, snakes, turtle, animal, vehicle, spaceman, science fiction character, character, pet, fish, creation, tree, plant, rock, rock, alien, monster, costume, fire engine, role-play costume, decor, play pattern, popping or ejecting toy(s) or object(s) with non-transportation, active features such as including but not limited to movement, sound, light, wherein at least one of the following if present can move, tail(s), eye(s), mouth(s), lip(s), arm(s), antennae, leg(s), body, head(s), wrist(s), engine(s) light(s), feet(s), hand(s), ear(s), tongue(s).

### DEFINITIONS

Seat Back—A part permanently or removably affixed to device via at least one part thereof such as the platform and/or the wheel base stemming therefrom in upward or angled upward direction, curved or straight for supporting or resting behind rider when rider is in a sitting position.

### LIST OF SOME KEY COMPONENTS AND FUNCTIONS

10—Flames move up and down out of engine as the transport vehicle moves

15—Engine makes noise as the Transport Vehicle moves

20—Engine vibrates as the Transport Vehicle moves

25—Head moves as the Transport Vehicle moves

30—Tail moves as the Transport Vehicle moves

35—Added Seated position

40—Removable Handle Bar converts to Push Bar

45—Attachable Rims

50—Characters can move multi direction as the Transport Vehicle moves

55—Attachable Wings move as the Transport Vehicle moves

60—Wings can alternatively move based on attachment to wheel rims

### DRAWINGS

The figures and drawings are filed at the same time as the application and are incorporated herein by this reference.

FIG. 1A and FIG. 1B: Both depict a Transportation Device that has appendages (in this embodiment wings) that articulate and move as the vehicle itself moves. This movement is achieved via an internal gear mechanism or by direct attachment to the wheels. FIG. 1A is a top view and shows a seat and a steering, balancing, stabilizing, or gripping device behind the seat for use by a non-rider. FIG. 1B is a front side view shows a seat and a steering, balancing, stabilizing, or gripping device in front of the seat for use by rider.

FIG. 2: Depicts permanently or removably attached to the vehicle or engine or molded to the Vehicle itself the following: 10 Depicts flames which move as the vehicle itself moves, 15 Depicts a sound box in which as the vehicle moves it creates sounds, 20 Depicts the engine in which vibrates and shakes as if it was an actual engine, which is created via the movement of the vehicle itself.

FIG. 3: Depicts the movements of the Transportation Device in which 25 Displays the head moving from side to side. 30 Displays the tail moving from side to side. 35 Shows an attachable seat feature with tail movement. 40 Displays the removable handle feature which can attach to the rear of the Transportation Device.

FIG. 4: Depicts the different handle bar locations as well as an attachable seat for the user.

FIG. 5: Depicts a Hot rod engine can be permanently or inserted into an attaching device located in the front Axel, wheelbase, steering column, handle bar, and or platform. 10 Displays the moving Flames that move up and down based on the movement of the vehicle. 45 depicts the attachable wheel rims which can be used for customization as well as safety for the optional wheel attachments.

FIG. 6: Depicts a Figure which can be placed into a basket like feature device where the Figure moves up and down as the vehicle moves.

FIG. 7a: Depicts an attachable wing system which moves from axis. 55 displays different type(s) of wing designs.

FIG. 7B: Depicts the way the Transportation Device can be assembled. Optionally the Seat can be left out where the Handle bar holds 55 in place.

FIG. 8A: Depicts a wheel attachment system in which the moving parts are powered by the wheels. Number 60 is displayed in FIGS. 8A, 8B, and 8C which are all 3 examples of application.

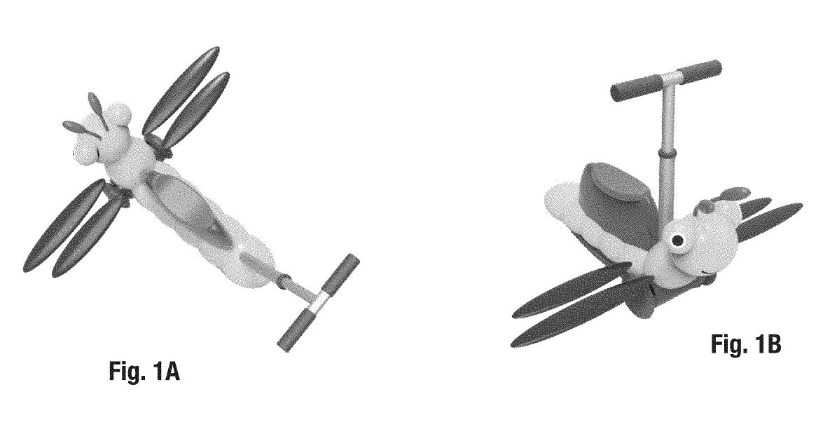

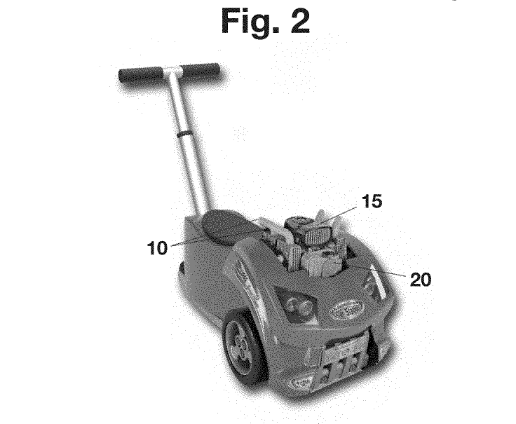

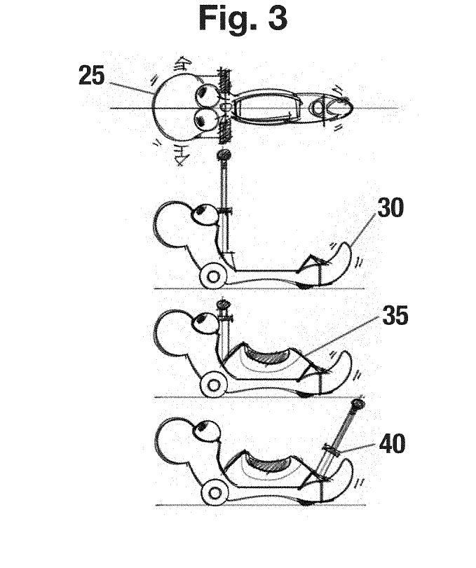

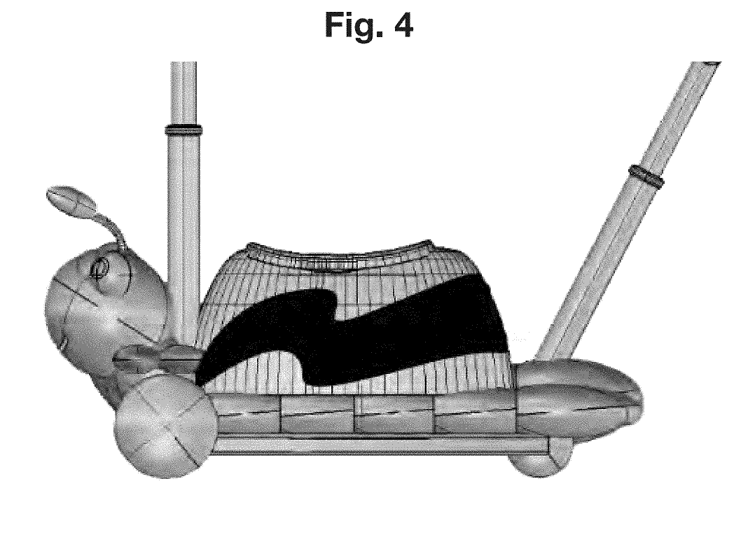

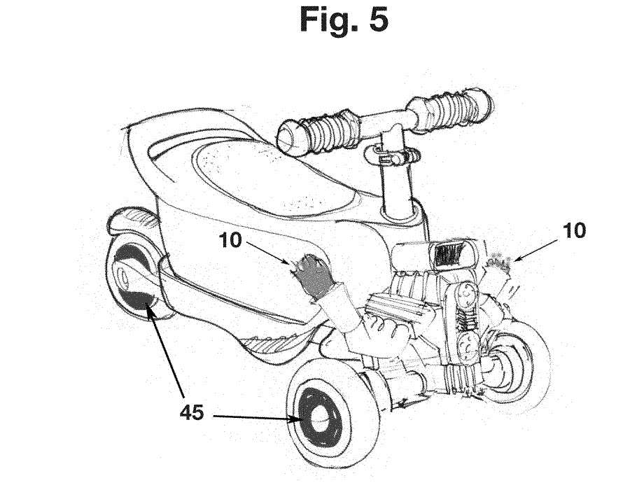

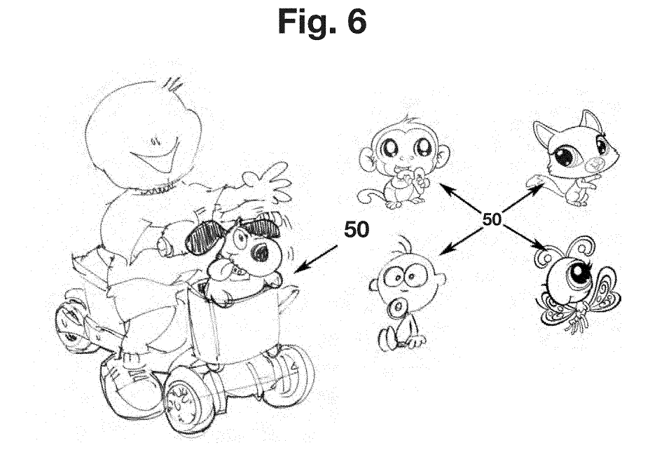

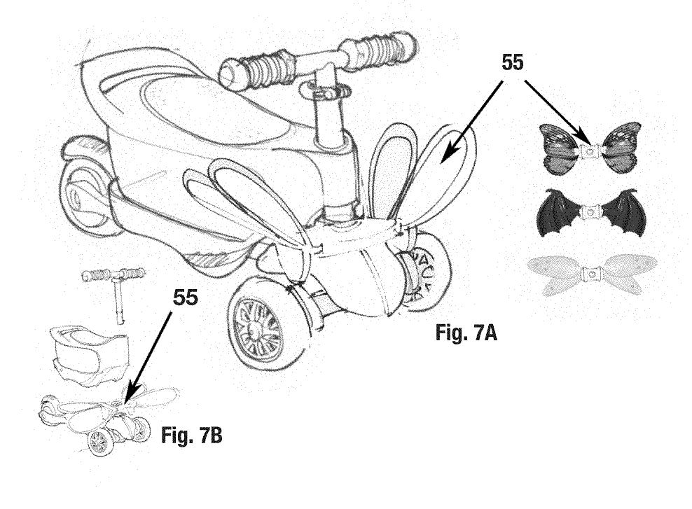

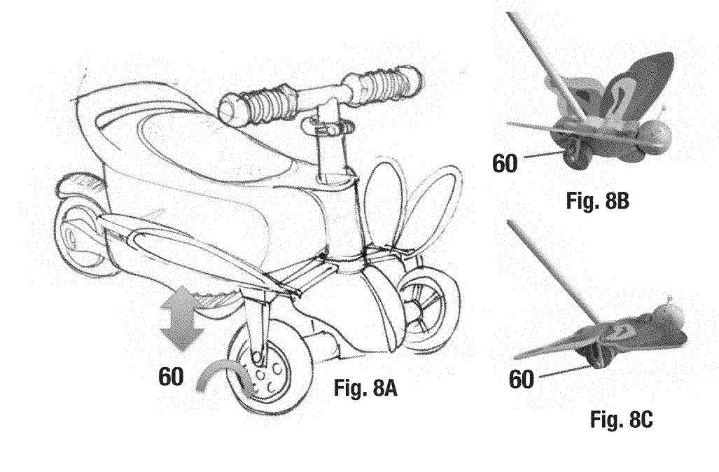

### DISCLAIMER EMBODIMENT LANGUAGE

It is to be understood that even though numerous characteristics and advantages of various embodiments of the present invention have been set forth the foregoing description together with details of the structure and function of the various embodiments of the invention in the detailed description is illustrative only and changes may be made, and especially in matters of structure and arrangement of parts within the principals of the present invention to the full extent indicated by the broad general meaning of the terms in which the claims are expressed.

Although various embodiments of the present invention have been described it will be understand by those skilled in the art that the present invention should not be limited to the described embodiments. Rather various changes and modifications can be made within the spirit and scope of the present invention.

What is claimed is:

1. A child's mobility and transportation Invention comprising:
at least one transportation device; and
at least one non-transportation device which includes at least one non-transportation feature or non-transportation feature device and said at least one non-transportation device is permanently or removably attached to said at least one transportation device:
said at least one transportation device further is comprised of the following:
at least one wheel or at least one wheel and associated wheel assembly unit;
at least one of: at least one wheel base, at least one platform;
at least one of the following:
at least one steering, balancing, stabilizing, and/or gripping device including at least one of a rod, neck, steering rod, a handle, or knob;
at least one steering, balancing, stabilizing, and/or gripping device, including at least one neck, rod, steering rod, handle, or knob that is permanently or removably affixed to or made part of the transportation device, or permanently or removably attached to an intermediary(s) that is permanently or removably affixed to or made part of the transportation device;
at least one attaching and/or connecting device for attaching and/or connecting the said steering, balancing, stabilizing, or gripping device, neck, rod, handle, knob, and/or steering rod to the wheel base, wheel(s), or an intermediary(s) or any other part of said transportation device;
said wheel base having said platform and mechanism or device for affixing, to as many as at least one wheel to a plurality of wheels or to said at least one-wheel assembly unit having said plurality of wheels and associated equipment;
the said attaching and/or connecting device attaches to said at least one wheel;
attaching and/or connecting device that attaches to at least one wheel and is permanently or removably attached to or is one or more of the parts of transportation device, and/or said intermediary(s) part(s), said wheel base, said platform, said mechanism or device for affixing, or said steering, balancing, stabilizing, gripping device, rod, handle, knob;
said at least one non-transportation feature(s) is/are powered electrically or mechanically;
said at least one non-transportation feature(s) is permanently or removably attached to transport device;

2. The invention of claim 1, whereby the non-transportation feature(s) in part or in whole powered mechanically or through mechanical connection to the wheels or intermediary(s) of the vehicle and additionally is comprised of a power generating device so that the rotation of the wheel(s) during movement activates and powers the non-transport features.

3. The invention is adapted with pedals for pedaling and to activate, control, and/or power the said non-transportation feature(s).

4. An ejecting mechanism may be included in some embodiments for at least one toy or other object ejecting into closed embodiments or into the ambient during use or movement of the invention.

5. The invention of claim 1, wherein at least one of a steering, balancing. stabilizing, gripping device or rod, handle, knob if present further comprises a turning feature or device;

6. The invention of claim 1, wherein various embodiments can be situated to accommodate the user in at least one of the following positions: standing, sitting, kneeling, or squatting.

7. The invention of claim 1, additionally comprising at least one seat, and/or seat back.

9. The invention of claim 1, additionally comprises at least one of the following: a wheel turning mechanism, front wheel turning rod, front wheel mount, pivot bolts, rear wheel axles and/or front wheel axles.

10. The invention of claim 1, additionally comprising a safety strap or other device to tether the device to at least one non-riding person.

11. The invention of claim 1, whereby the device in part or in whole is made of at least one of the following: plastic, rubber wood, metal, nylon, fabric, ceramic, fiberglass, and/or polyurethane.

12. The invention of claim 1, whereby the associated equipment comprises at least one of the following: screws, nuts, bolts, at least one axle, rim(s), hub caps, or caps, covers, ball bearings, spokes, front wheel(s), rear wheel(s), front wheel turning rod, rear wheel turning rod, front wheel mounts and pivot bolts, rear wheel mounts and pivot bolts, rear wheel axles, front wheel axles, rubber, plastic, metal, fiberglass, or polyurethane.

13. The invention of claim 1, wherein said at least one non-transportation feature is or includes at least one of the following:
at least one design or shape;
at least one design or shape such as in part or in whole, in singular or in plural: butterfly, snake, turtle, animal, vehicle, spaceman, science fiction character, character, pet, fish, creature, thing, object, fish, tree, plant, image, train, vehicle, ship, boat, jet, rocket, plane, truck, rock, alien, monster, costume, fire engine, role-play costume, decor, play pattern, popping or ejecting toy(s) or object(s);
with non-transportation active features such as, including but not limited to, movement, sound, light, wherein at least one of the following if present can move: tail(s), eye(s), mouth(s), lip(s), arm(s), wing(s), antennae, leg(s), body, body part(s), head(s), head part(s), wrist(s), finger(s), toe(s), engine(s), light(s), feet(s), hand(s), ear(s), tongue(s).
